(19) United States
(12) Patent Application Publication
(10) Pub. No.: US 2017/0345000 A1
(43) Pub. Date: Nov. 30, 2017

(54) SYSTEM AND METHODS FOR ENHANCED PAYMENT AUTHENTICATION USING MERCHANT LOYALTY SCHEME

(71) Applicant: MasterCard International Incorporated, Purchase, NY (US)

(72) Inventor: Manoneet Kohli, O'Fallon, MO (US)

(21) Appl. No.: 15/164,343

(22) Filed: May 25, 2016

(51) Int. Cl. G06Q 20/40; G06Q 30/02

(52) U.S. Cl. CPC G06Q 20/4014; G06Q 30/0233

(57) ABSTRACT

A computer-implemented method for enhancing payment transaction authentication using a merchant loyalty scheme is provided. The method is implemented using a verification computer device in communication with a memory. The method includes receiving an authentication request message for a payment transaction originating from an originating merchant for a cardholder. The authentication request message includes a reward redemption flag. The method also includes determining that an authentication challenge is needed based on the authentication request message, transmitting an authentication challenge to the user if the reward redemption flag is not set, determining that the authentication challenge may be bypassed based on the reward redemption flag if the reward redemption flag is set, generating an authentication response message based, at least in part, on at least one of reward redemption flag and the authentication challenge, and transmitting the authentication response message to the originating merchant.

### BACKGROUND OF THE DISCLOSURE

The field of the disclosure relates generally to enhancing fraud detection, and more specifically to methods and systems for authenticating a transaction based on a redeemed reward associated with a merchant loyalty scheme.

At least some known credit/debit card purchases involve fraudulent activity. These fraudulent transactions present liability issues to one or more parties involved in the transaction, such as an issuing bank, a merchant, a payment processing network, or an acquirer bank. As such, these parties are interested in fraud detection, or the ability to analyze the data surrounding a payment card transaction before authorizing the transaction. For example, in online transactions through a merchant web site or “card-not-present” transactions, the merchant party in the transaction may assume initial liability for certain aspects of the transaction unless, for example, certain risk-mitigating steps are taken.

One such risk-mitigating step is cardholder authentication. For example, some payment networks engage an authentication service that performs an authentication of a suspect consumer prior to authorization of the transaction. The authentication service determines if the source of the transaction is the authorized user of the payment card. In addition to the authentication system, many known systems also use a fraud scoring system to detect potentially fraudulent transactions. There exists a need for more advanced fraud detection systems.

### BRIEF DESCRIPTION OF THE DISCLOSURE

A computer-implemented method for enhancing payment transaction authentication using a merchant loyalty scheme is provided. The method is implemented using a verification computer device in communication with a memory. The method includes receiving an authentication request message for a payment transaction originating from an originating merchant for a cardholder. The authentication request message includes a reward redemption flag. The method also includes determining that an authentication challenge is needed based on the authentication request message, transmitting an authentication challenge to the user if the reward redemption flag is not set, determining that the authentication challenge may be bypassed based on the reward redemption flag if the reward redemption flag is set, generating an authentication response message based, at least in part, on at least one of reward redemption flag and the authentication challenge, and transmitting the authentication response message to the originating merchant.

A verification computer device used to enhance payment transaction authentication using a merchant loyalty scheme is provided. The verification computer device includes a processor communicatively coupled to a memory device. The processor is programmed to receive an authentication request message for a payment transaction originating from an originating merchant for a cardholder. The authentication request message includes a reward redemption flag. The processor is also programmed to determine that an authentication challenge is needed based on the authentication request message, transmit an authentication challenge to the user if the reward redemption flag is not set, determine that the authentication challenge may be bypassed based on the reward redemption flag if the reward redemption flag is set, generate an authentication response message based, at least in part, on at least one of reward redemption flag and the authentication challenge, and transmit the authentication response message to the originating merchant.

At least one non-transitory computer-readable storage media having computer-executable instructions embodied thereon is provided. When executed by a verification computer device having at least one processor coupled to at least one memory device, the computer-executable instructions cause the processor to receive an authentication request message for a payment transaction originating from an originating merchant for a cardholder. The authentication request message includes a reward redemption flag. The computer-executable instructions also cause the processor to determine that an authentication challenge is needed based on the authentication request message transmit an authentication challenge to the user if the reward redemption flag is not set, determine that the authentication challenge may be bypassed based on the reward redemption flag if the reward redemption flag is set, generate an authentication response message based, at least in part, on at least one of reward redemption flag and the authentication challenge, and transmit the authentication response message to the originating merchant.

### BRIEF DESCRIPTION OF THE DRAWINGS

FIGS. 1-6 show example embodiments of the methods and systems described herein.

FIG. 1 is a schematic diagram illustrating an example multi-party transaction card industry system for enabling payment-by-card transactions in which merchants and card issuers do not need to have a one-to-one relationship.

FIG. 2 is a simplified block diagram of an example system used for enhancing payment transaction authentication using a merchant loyalty scheme.

FIG. 3 illustrates an example configuration of a client system shown in FIG. 2, in accordance with one embodiment of the present disclosure.

FIG. 4 illustrates an example configuration of a server system shown in FIG. 2, in accordance with one embodiment of the present disclosure.

FIG. 5 is a flow chart of a process for enhancing payment transaction authentication using a merchant loyalty scheme using the system shown in FIG. 2.

FIG. 6 is a diagram of components of one or more example computing devices that may be used in the system shown in FIG. 2.

### DETAILED DESCRIPTION OF THE DISCLOSURE

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. These system and methods to enhance payment transaction authentication using a merchant loyalty scheme.

One risk-mitigating step against fraudulent cardholder transactions is cardholder authentication. For example, some payment networks engage an authentication service that performs an authentication of a suspect consumer prior to authorization of the transaction. The authentication service determines if the source of the transaction is the authorized user of the payment card. During such authentication, the suspect consumer (i.e., the person attempting to perform the payment card transaction with the merchant) may be presented with an authentication challenge, sometimes called a “step-up challenge.” This step-up challenge generally requires the suspect consumer to provide a password or a passcode from a second factor device before the transaction will be processed. By obtaining this additional factor from the suspect consumer, the likelihood of the suspect consumer being a fraudulent consumer is reduced. However, this extra step presents an interruptive inconvenience, a barrier, or an interference to at least some legitimate consumers and subsequently causes at least some consumers to abandon legitimate transactions. These abandonments results in lost revenues to many parties, such as the merchant, the merchant acquirer, and the issuer.

In the example embodiment, a verification computer device (also known as a verification server) includes a processor in communication with a memory. The verification computer device is in communication with a payment processing network. In some embodiments, the verification computer device may be a part of the payment processing network, for example the network interchange, or the verification computer device may be separate from the payment processing network and merely in communication with the payment processing network. The payment processing network includes a point of sale, a merchant, a merchant bank, an interchange network, and an issuing bank (also known as an issuer processor). The verification computer device is configured to determine determines if the source of the transaction is the authorized user of the payment card to assist the merchant in determining whether to approve or deny the candidate online payment transaction.

In the example embodiment, the verification computer device receives authentication data from a merchant about a candidate online payment transaction. The candidate online payment transaction is for a payment card transaction through a website associated with the merchant. The authentication data includes a plurality of data elements about the candidate cardholder and the payment transaction (i.e., shipping address, billing address, and device identifiers). In the example embodiment, the verification computer device receives an authentication request message for a payment transaction originating from an originating merchant for a cardholder. The authentication request message includes a reward redemption flag indicating that the candidate cardholder redeemed a reward associated with the merchant's loyalty program. The redeemed reward was a unique reward that what uniquely tied to the candidate cardholder. The verification computer device determines if a authentication challenge is needed to authenticate the candidate cardholder. If the reward redemption flag is not set, the verification computer device transmits an authentication challenge to the user. If the reward redemption flag is set, the verification computer device determines that the authentication challenge was successfully responded to or that the authentication challenge may be bypassed. The verification computer device also considers the payment transaction to be a low-risk transaction based on the reward redemption flag being set. The verification computer device generates an authentication response message based, at least in part, on at least one of reward redemption flag and the authentication challenge. Then the verification computer device transmits the authentication response message to the originating merchant.

In the example embodiment, the verification computer device receives authentication data for a candidate online payment transaction from a merchant. The candidate online payment transaction is a payment transaction that a cardholder conducts with the merchant via a website or an app (i.e., hosted on a mobile device) associated with the merchant. In the example embodiment, the candidate online payment transaction is a card-not-present transaction that occurs via a website or application, such as over the Internet. The authentication data is data used to determine if the source of the payment transaction is the authorized user of the payment card.

In some embodiments, authentication data includes one or more of: (1) consumer device attributes such as, for example, device attribute data (i.e., data derived from the device that the cardholder is transacting from, which can ultimately be used for creating a device fingerprint, and which may include IP address, physical address associated with IP address, device type, and phone number), and geo-location data (i.e., data from the device of the cardholder, indicating the assessed location of the device, such as GPS location, country, city, etc.); (2) data from the merchant such as, for example, consumer contact information (personally identifiable information (PII) about the cardholder associated with the payment account that the candidate online payment transaction is for, which will be used to determine the likelihood that the merchant has the correct cardholder, and which may include email address, mobile phone number, landline phone number, confirmed shipping address, and consumer identity verification (e.g., anonymous, unverified, externally scored (e.g., credit reference agency), authentic issued official ID (e.g., passport, driver's license)), and age of cardholder relationship); and (3) merchant reference data such as, for example, days account has been on file with the merchant, days since the cardholder last used the card on file, verification method of the cardholder performed by the merchant at the time of candidate online payment transaction, purchases information (i.e., type of goods/services provided-digital only, low value, high value with verified address, in-store), and a merchant risk score (i.e., a risk score derived from the merchant's risk systems and reference data, also known as a merchant fraud grading). In some embodiments, the merchant risk score may also include one or more merchant reason codes, which are codes that represent why the merchant assigned that particular merchant risk score to the candidate online payment transaction.

Many people belong to loyalty reward programs associated with merchants. The merchants associated with these loyalty programs provide rewards to each individual member based on the purchases that the member makes with the associated merchant. In many programs, a reward is provided when the member spends a certain amount of money with the merchant. For example, one loyalty program may provide the member with a $5 off reward every time the member spends $100 with the merchant. Other loyalty programs provide rewards based on the number transactions that the member completes with the merchant. The reward may be provided as a redemption code, where the redemption code is generated to be unique for the member and for the reward. For example, a single member may have received three different rewards and each one has a different unique redemption code. The unique code provides a way for the merchant to track and authenticate the redemption reward.

In the example embodiment, a member uses an earned redemption reward by entering the associated reward code while at the checkout of a payment transaction. In some embodiments, the reward code may be entered at the checkout of an ecommerce transaction. In other embodiments, the reward code may be scanned from a coupon at a physical checkout, i.e., at a brick and mortar location. The merchant confirms that that reward code is associated with that member. The merchant may also confirm that the reward code has not been previously used and that the reward code is appropriate for the current transaction. If the reward code is confirmed, then the merchant reduces the transaction amount based on the reward.

For the purposes of this application, the reward codes described herein are unique reward codes. In the example embodiment, a member purchases over $100 from a merchant associated with a loyalty program. The member receives a $5 coupon for use with transactions with the merchant. This $5 coupon is a unique coupon only for that member. In the example embodiment, the member receives a unique code as a part of the coupon. In some embodiments, this code is in the form of an alphanumeric code that the member has to enter in the shopping cart at the merchant's webstore. In other embodiments, the code is encoded in a bar code or QR code that the member could scan as a part of the purchase transaction. However, the code will only work once and is directly associated with the member and the member's loyalty program account.

The verification computer device determines whether an authentication challenge is needed based on the authentication data included in the authentication request message. In the example embodiment, the verification computer device determines that an authentication challenge is needed when the authentication data does not provide enough to confirm or authenticate the candidate cardholder. In this situation, the verification computer device determines that it will be able to finish authenticating the identity of candidate cardholder based on the results of the authentication challenge. Examples of authentication challenges, also known as step-up challenges, include but are not limited to, a static password request, a request for biometric data (i.e., fingerprint), a one-time password request, a challenge question, or any other form that requires candidate cardholder to perform an action to confirm his or her identity.

If the reward redemption flag was not set in the authentication request message, the verification computer device transmits the authentication challenge to the candidate cardholder. The results of the authentication challenge are received by the verification computer device. In some embodiments, the verification computer device receives and compares the raw data received from the candidate cardholder in response to the authentication challenge to determine the results of the authentication challenge. In other embodiments, the determination is performed by the merchant and the verification computer device receives the results from the merchant. In some embodiments, the verification computer device transmits the authentication challenge directly to the candidate cardholder. In other embodiments, the verification computer device transmits the authentication challenge to the merchant, which transmits the authentication challenge to the candidate cardholder.

If the redemption reward flag is set in the authentication request message, the verification computer device determines that the authentication challenge has already been successfully was successfully responded to or that the authentication challenge may be bypassed. The verification computer device considers the payment transaction to be a low-risk transaction. Therefore, the verification computer device does not transmit an authentication challenge to the candidate cardholder and authenticates the candidate cardholder.

The verification computer device generates an authentication response message. The authentication response message is based on the authentication challenges and the reward redemption flag. If the authentication challenge was transmitted and successfully answered or if the reward redemption flag was set, then the authentication response message authenticates the candidate cardholder. If the challenge question failed, then the authentication response message does not authenticate the candidate cardholder. The verification computer device transmits the authentication response message to the originating merchant.

In some embodiments, the verification computer device also performs the validation of the unique reward code. In these embodiments, the verification computer device receives the unique reward code entered by the candidate cardholder and other identifying information about the candidate cardholder. For example, the other identifying information may be the candidate cardholder's account number for the merchant loyalty program. The verification computer device uses the identifying information to determine the merchant loyalty program account associated with the candidate cardholder. The verification computer device then compares the unique reward code with those unique reward codes associate with the candidate cardholder's account. If there is a match, where a unique reward code that matches the received unique reward code was issued to the candidate cardholder, then the verification computer device validates the unique reward code and transmits the positive validation to the merchant. In some of these embodiments, the verification computer device also confirms that the unique reward code has not been previously used and/or is still valid.

In the embodiments where the verification computer device validates the unique reward code, the verification computer device may not receive a reward redemption flag in the authentication request message. In these embodiments, the validation computer device may consider the reward redemption flag to be set, based on the verification computer device's previous validation of the unique reward code.

In some embodiments, the verification computer device is in communication with a reward validation device. The reward validation device validates the unique reward code for the merchant. In these embodiments, the verification computer device is able to transmit a request to the reward validation device to receive some or all of the information about the candidate cardholder. For example, the verification computer device may be able to access the name and address stored in the candidate cardholder's reward account. The verification computer device may then compare that information to the authentication data to authenticate the candidate cardholder.

The methods and system described herein may be implemented using computer programming or engineering techniques including computer software, firmware, hardware, or any combination or subset. As disclosed above, at least one technical problem with prior systems is that there is a need for enhanced payment transaction authentication. The system and methods described herein address that technical problem. The technical effect of the systems and processes described herein is achieved by performing at least one of the following steps: (a) receiving an authentication request message for a payment transaction originating from an originating merchant for a cardholder, the authorization request message includes a reward redemption flag; (b) determine a fraud score for the cardholder based on the authorization request message; (c) determine that an authentication challenge is needed based on the fraud score; (d) if the reward redemption flag is not set, transmit an authentication challenge to the user; (e) if the reward redemption flag is set, determine that the authentication challenge may be bypassed based on the reward redemption flag; (f) generate the authentication response message based, at least in part, on the fraud score, the reward redemption flag, and the authentication challenge; and (g) transmit the authentication response message to the originating merchant. The resulting technical effect is that a more accurate authentication system provides a method of using redeemed loyalty program rewards for authentication of the associated payment transaction.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

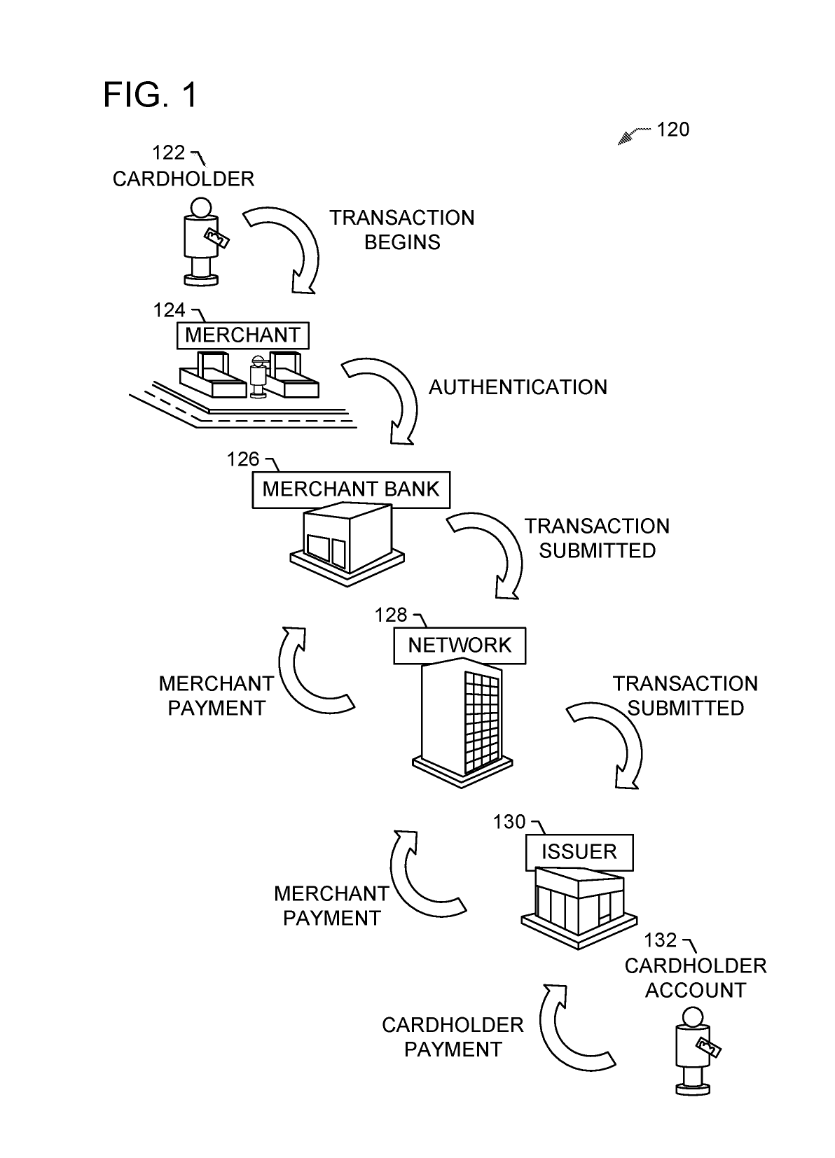

FIG. 1 is a schematic diagram illustrating an example multi-party transaction card industry system 120 for enabling payment-by-card transactions in which merchants 124 and card issuers 130 do not need to have a one-to-one relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card or electronic payments account identifier, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

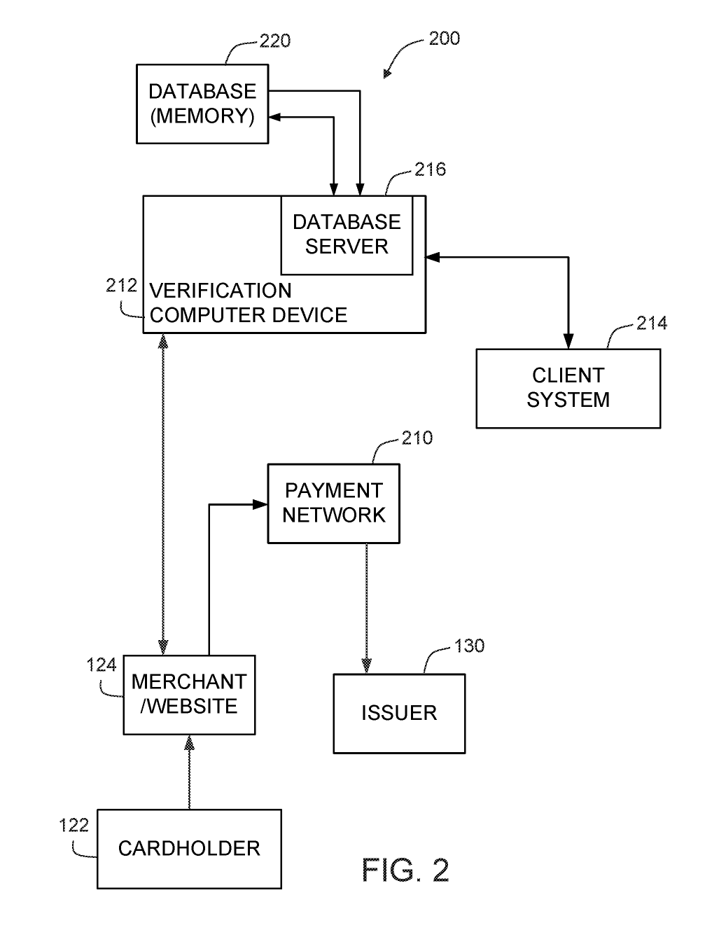

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

FIG. 2 is a simplified block diagram of an example system 200 used for enhancing payment transaction authentication using a merchant loyalty scheme. In the example embodiment, system 200 may be used for performing payment-by-card transactions received as part of processing cardholder transactions. In addition, system 200 is a payment processing system that includes a verification computer device 212 configured to enhancing payment transaction authentication using a merchant loyalty scheme. As described below in more detail, verification computer device 212 is configured to receive an authentication request message for a payment transaction originating from an originating merchant 124 for a cardholder 122 (both shown in FIG. 1). The authentication request message includes a reward redemption flag. Verification computer device 212 is configured to determine that an authentication challenge is needed based on the authentication request message. If the reward redemption flag is not set, verification computer device 212 is configured to transmit an authentication challenge to the user. If the reward redemption flag is set, verification computer device 212 is configured to determine that the authentication challenge was successfully responded to or that the authentication challenge may be bypassed. Verification computer device 212 also considers the payment transaction to be a low-risk transaction based on the reward redemption flag being set. Verification computer device 212 is further configured to generate an authorization response message based, at least in part, on at least one of reward redemption flag and the authentication challenge and transmit the authentication response message to originating merchant 124.

In the example embodiment, client systems 214 are computers that include a web browser or a software application to enable client systems 214 to access verification computer device 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment. In the example embodiment, cardholder 122 uses a client system 214 to access a commerce website for merchant 124.

A database server 216 is communicatively coupled to a database 220 that stores data. In one embodiment, database 220 includes authentication data, authentication challenges, unique reward codes, and merchant loyalty schemes. In the example embodiment, database 220 is stored remotely from verification computer device 212. In some embodiments, database 220 is decentralized. In the example embodiment, a person can access database 220 via client systems 214 by logging onto verification computer device 212, as described herein.

Verification computer device 212 is communicatively coupled with payment network 210. Payment network 210 represents one or more parts of payment network 120 (shown in FIG. 1). In the example embodiment, verification computer device 212 is in communication with one or more computer devices associated with interchange network 128. In other embodiments, verification computer device 212 is in communication with one or more computer devices associated with merchant bank 126 (shown in FIG. 1). In some embodiments, verification computer device 212 may be associated with, or is part of payment network 120, or in communication with payment network 120, shown in FIG. 1. In other embodiments, verification computer device 212 is associated with a third party and is in communication with payment network 120. In some embodiments, verification computer device 212 may be associated with, or be part of merchant bank 126, interchange network 128, and issuer bank 130. In addition, verification computer device 212 is communicatively coupled with merchant 124. In the example embodiment, verification computer device 212 is in communication with merchant 124 and client systems 214 via Application Programming Interface (API) calls. Through the API call, merchant 124 may transmit information to and receive information from verification computer device 212.

In some embodiments, verification computer device 212 may be associated with the financial transaction interchange network 128 shown in FIG. 1 and may be referred to as an interchange computer system. Verification computer device 212 may be used for processing transaction data and analyzing for fraudulent transactions. In addition, at least one of client systems 214 may include a computer system associated with an issuer 130 of a transaction card. Accordingly, verification computer device 212 and client systems 214 may be utilized to process transaction data relating to purchases a cardholder 122 makes utilizing a transaction card processed by interchange network 128 and issued by the associated issuer 130. At least one client system 214 may be associated with a user or a cardholder 122 seeking to register, access information, or process a transaction with at least one of interchange network 128, issuer 130, or merchant 124. In addition, client systems 214 may include point-of-sale (POS) devices associated with merchant 124 and used for processing payment transactions.

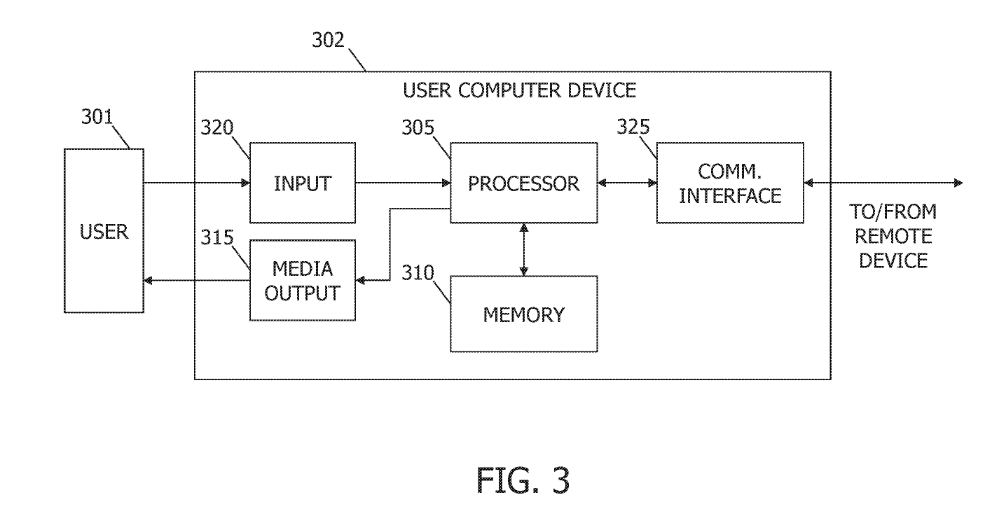

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214, computer devices associated with merchant 124, and computer devices associated with cardholder 122 (both shown in FIG. 1). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer-readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as verification computer device 212 (shown in FIG. 2). Communication interface 325 may include, for example, a wired or wireless network adapter and/or a wireless data transceiver for use with a mobile telecommunications network.

Stored in memory area 310 are, for example, computer-readable instructions for providing a user interface to user 301 via media output component 315 and, optionally, receiving and processing input from input device 320. The user interface may include, among other possibilities, a web browser and/or a client application. Web browsers enable users, such as user 301, to display and interact with media and other information typically embedded on a web page or a website from verification computer device 212. A client application allows user 301 to interact with, for example, verification computer device 212. For example, instructions may be stored by a cloud service and the output of the execution of the instructions sent to the media output component 315.

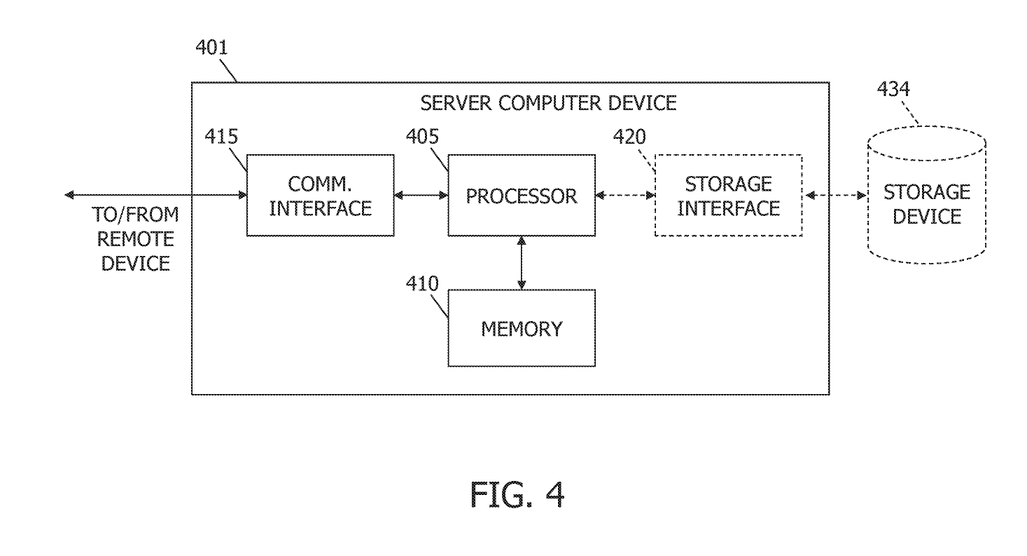

FIG. 4 illustrates an example configuration of a server system shown in FIG. 2, in accordance with one embodiment of the present disclosure. Server computer device 401 may include, but is not limited to, database server 216, merchant/website server 124, and verification computer device 212 (all shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, merchant/website server 124, or verification computer device 212 (all shown in FIG. 2). For example, communication interface 415 may receive requests from client systems 214 via the Internet.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

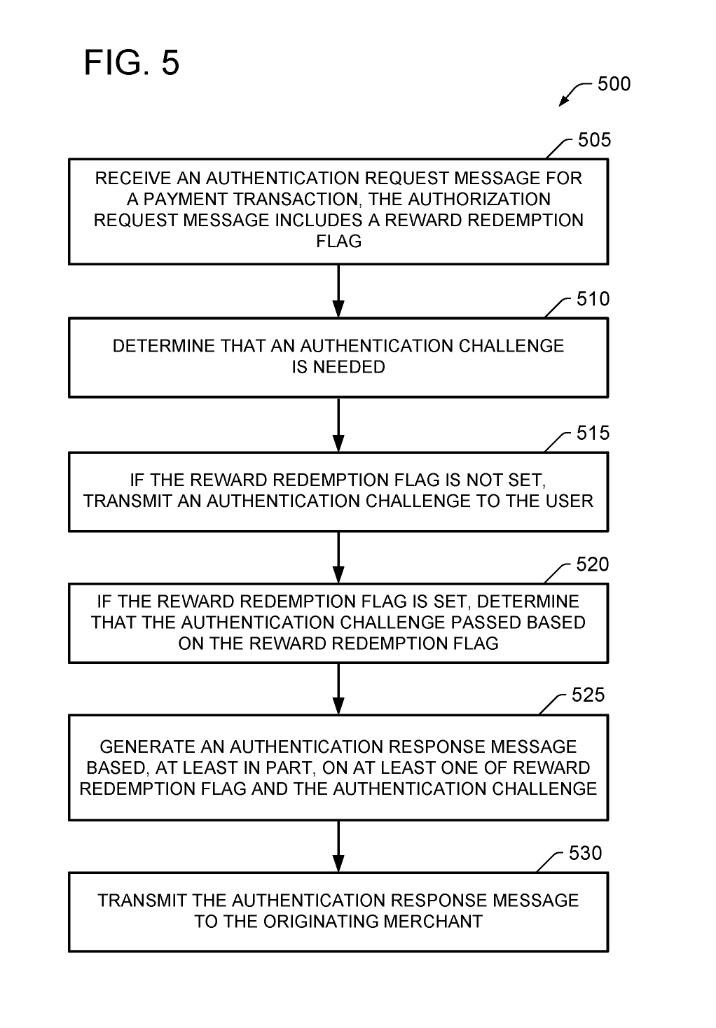

Processor 405 executes computer-executable instructions for implementing aspects of the disclosure. In some embodiments, processor 405 is transformed into a special purpose microprocessor by executing computer-executable instructions or by otherwise being programmed. For example, processor 405 is programmed with the instructions such as are illustrated in FIG. 5.

FIG. 5 is a flow chart of a process 500 for enhancing payment transaction authentication using a merchant loyalty scheme using system 200 shown in FIG. 2. In the example embodiment, process 500 is performed by verification computer device 212 (shown in FIG. 2).

In the example embodiment, verification computer device 212 receives 505 authentication request message for a candidate online payment transaction from merchant 124 (shown in FIG. 1). The candidate online payment transaction is a payment transaction that candidate cardholder 122 (shown in FIG. 1) conducts with merchant 124 via a website associated with merchant 124. The authentication request message includes authentication data that is used to determine if the source of the payment transaction is the authorized user of the payment card. The authentication request message also includes a reward redemption flag, which when set, indicates that candidate cardholder 122 redeemed a unique reward associated with originating merchant 124 in the candidate online payment transaction. In the example embodiment, the unique reward was redeemed by candidate cardholder 122 entering a unique reward code associated with the unique reward into merchant/website 124. Merchant/website 124 then validated the unique reward code to confirm that the unique reward code was associated with the candidate cardholder and had not been previously redeemed. Upon validation of the reward, the merchant/website 124 updated the candidate cardholder's total purchase amount. For example, the unique reward was for $5 off of a purchase. Once the reward was validated, merchant/website reduced the total for candidate cardholder's transaction by $5.

In some embodiments, authentication data includes one or more of: (1) consumer device attributes such as, for example, device attribute data (i.e., data derived from the device that cardholder 122 is transacting from, which can ultimately be used for creating a device fingerprint, and which may include IP address, physical address associated with IP address, device type, and phone number), and geo-location data (i.e., data from the device of cardholder 122, indicating the assessed location of the device, such as GPS location, country, city, etc.); (2) data from merchant 124 such as, for example, consumer contact information (personally identifiable information (PII) about cardholder 122 associated with payment account 132 (shown in FIG. 1) that the candidate online payment transaction is for, which will be used to determine the likelihood that merchant 124 has the correct cardholder 122, and which may include email address, mobile phone number, landline phone number, confirmed shipping address, and consumer identity verification (e.g., anonymous, unverified, externally scored (e.g., credit reference agency), authentic issued official ID (e.g., passport, driver's license)), and age of cardholder relationship); and (3) merchant reference data such as, for example, days account has been on file with merchant 124, days since cardholder 122 last used the card on file, verification method of cardholder 122 performed by merchant 124 at the time of candidate online payment transaction, purchases information (i.e., type of goods/services provided-digital only, low value, high value with verified address, in-store), and a merchant risk score (i.e., a risk score derived from the merchant's risk systems and reference data, also known as a merchant fraud grading). In some embodiments, the merchant risk score may also include one or more merchant reason codes, which are codes that represent why merchant 124 assigned that particular merchant risk score to the candidate online payment transaction.

Verification computer device 212 determines 510 whether an authentication challenge is needed based on the authentication data included in the authentication request message. In the example embodiment, verification computer device 212 determines 510 that an authentication challenge is needed when the authentication data does not provide enough to confirm or authenticate candidate cardholder 122. In this situation, verification computer device 212 determines that it will be able to finish authenticating the identity of candidate cardholder based on the results of the authentication challenge. Examples of authentication challenges, also known as step-up challenges, include but are not limited to, a static password request, a request for biometric data (i.e., fingerprint), a one-time password request, a challenge question, or any other form that requires candidate cardholder to perform an action to confirm his or her identity.

If the reward redemption flag was not set in the authentication request message, verification computer device 212 transmits 515 the authentication challenge to candidate cardholder 122. The results of the authentication challenge are received by verification computer device 212. In some embodiments, verification computer device 212 receives and compares the raw data received from candidate cardholder 122 in response to the authentication challenge to determine the results of the authentication challenge. In other embodiments, the determination is performed by merchant/website 124 (shown in FIG. 1) and verification computer device 212 receives the results from merchant/website 124. In some embodiments, verification computer device 212 transmits 515 the authentication challenge directly to candidate cardholder 122. In other embodiments, verification computer device 212 transmits 515 the authentication challenge to merchant/website 124, which transmits the authentication challenge to candidate cardholder 122.

If the redemption reward flag is set in the authentication request message, verification computer device 212 determines 520 that the authentication challenge has already been successfully was successfully responded to or that the authentication challenge may be bypassed. Verification computer device 212 also considers the payment transaction to be a low-risk transaction. Therefore, verification computer device 212 does not transmit an authentication challenge to candidate cardholder 122 and authenticates candidate cardholder 122.

Verification computer device 212 generates 525 an authentication response message. The authentication response message is based on the authentication challenges and the reward redemption flag. If the authentication challenge was transmitted and successfully answered or if the reward redemption flag was set, then the authentication response message authenticates candidate cardholder 122. If the challenge question failed, then the authentication response message does not authenticate candidate cardholder 122. Verification computer device 212 transmits 530 the authentication response message to originating merchant 124.

In the example embodiment, verification computer device 212 is in direct communication with merchant/website 124. In other embodiments, verification computer device 212 is in indirect communication with merchant/website 124 and receives and transmits messages through different servers.

In some embodiments, verification computer device 212 also performs the validation of the unique reward code. In these embodiments, verification computer device 212 receives the unique reward code entered by candidate cardholder 122 and other identifying information about candidate cardholder 122. For example, the other identifying information may be the candidate cardholder's account number for the merchant loyalty program. Verification computer device 212 uses the identifying information to determine the merchant loyalty program account associated with candidate cardholder 122. Verification computer device 212 then compares the unique reward code with those unique reward codes associate with the candidate cardholder's account. If there is a match, where a unique reward code that matches the received unique reward code was issued to the candidate cardholder 122, then verification computer device 212 validates the unique reward code and transmits the positive validation to merchant/website 124. In some of these embodiments, verification computer device 212 also confirms that the unique reward code has not be previously used and/or is still valid.

In the embodiments where verification computer device 212 validates the unique reward code, verification computer device 212 may not receive a reward redemption flag in the authentication request message. In these embodiments, validation computer device 212 may consider the reward redemption flag to be set, based on verification computer device's previous validation of the unique reward code.

In some embodiments, verification computer device 212 is in communication with a reward validation device (not shown). The reward validation device validates the unique reward code for merchant/website 124. In these embodiments, verification computer device 212 is able to transmit a request to the reward validation device to receive some or all of the information about the candidate cardholder 122. For example, verification computer device 212 may be able to access the name and address stored in the candidate cardholder's reward account. Verification computer device 212 may then compare that information to the authentication data to authenticate the candidate cardholder 122.

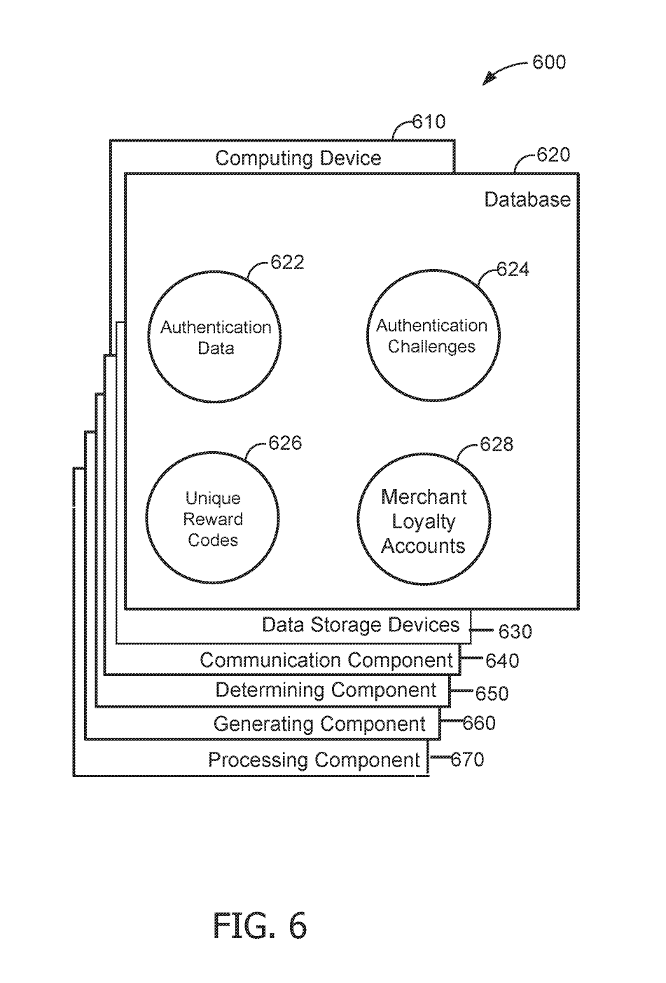

FIG. 6 is a diagram 600 of components of one or more example computing devices that may be used in system 200 shown in FIG. 2. In some embodiments, computing device 610 is similar to verification computer device 212 (shown in FIG. 2). Database 620 may be coupled with several separate components within computing device 610, which perform specific tasks. In this embodiment, database 620 includes authentication data 622, authentication challenges 624, unique reward codes 626, and merchant loyalty schemes 628. In some embodiments, database 620 is similar to database 220 (shown in FIG. 2).

Computing device 610 includes database 620, as well as data storage devices 630. Computing device 610 also includes a communication component 640 for receiving 505 an authorization request, transmitting 515 an authentication challenge, and transmitting 530 the authorization response message (all shown in FIG. 5). Computing device 610 also includes a determining component 650 for determining that an authentication challenge is needed and determining 520 that the authentication challenge may be bypassed (both shown in FIG. 5). Computing device 610 further includes a generating component 660 for generating 525 an authorization response message. A processing component 670 assists with execution of computer-executable instructions associated with the system.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal languages of the claims.

What is claimed is:

1. A computer-based method for enhancing payment transaction authentication using a merchant loyalty scheme, said method implemented using a verification computing device in communication with a memory, said method comprising:
receiving, at the verification computing device, an authentication request message for a payment transaction originating from an originating merchant for a cardholder, the authentication request message includes a reward redemption flag;
determining, at the verification computing device, that an authentication challenge is needed based on the authentication request message;
if the reward redemption flag is not set, transmitting, by the verification computing device, an authentication challenge to the user;
if the reward redemption flag is set, determining, by the verification computing device, that the authentication challenge may be bypassed based on the reward redemption flag being set;
generating, by the verification computing device, an authentication response message based, at least in part, on at least one of reward redemption flag and the authentication challenge; and
transmitting, by the verification computing device, the authentication response message to the originating merchant.

2. A method in accordance with claim 1, further comprising:
determining a fraud score for the cardholder based on the authentication request message; and
determining that an authentication challenge is needed based on the fraud score.

3. A method in accordance with claim 2, wherein generating an authentication response method further comprises generating the authentication response message based, at least in part, on the fraud score, the reward redemption flag, and the authentication challenge.

4. A method in accordance with claim 1, wherein the reward redemption flag is set when the payment transaction includes a reward redemption initiated by the cardholder.

5. A method in accordance with claim 4, wherein the reward redemption is initiated by the cardholder providing a unique reward code to the originating merchant.

6. A method in accordance with claim 5, wherein the unique reward code provides a discount on the payment transaction.

7. A method in accordance with claim 5, wherein the unique reward code is provided to the cardholder from a merchant loyalty scheme associated with the originating merchant.

8. A method in accordance with claim 5, wherein the unique reward code is uniquely correlated with the cardholder and the unique reward code is for a single use.

9. A method in accordance with claim 5, wherein the unique reward code is provided to the cardholder based on one or more purchases associate with the originating merchant.

10. A verification computer device used for enhanced payment transaction authentication using a merchant loyalty scheme, said verification device comprising a processor communicatively coupled to a memory device, said processor programmed to:
receive an authentication request message for a payment transaction originating from an originating merchant for a cardholder, the authentication request message includes a reward redemption flag;
determine that an authentication challenge is needed based on the authentication request message;
if the reward redemption flag is not set, transmit an authentication challenge to the user;
if the reward redemption flag is set, determine that the authentication challenge may be bypassed based on the reward redemption flag;
generate an authentication response message based, at least in part, on at least one of reward redemption flag and the authentication challenge; and
transmit the authentication response message to the originating merchant.

11. A verification computer device in accordance with claim 10, wherein said processor is further programmed to:
determine a fraud score for the cardholder based on the authentication request message; and
determine that an authentication challenge is needed based on the fraud score.

12. A verification computer device in accordance with claim 11, wherein said processor is further programmed to generate the authentication response message based, at least in part, on the fraud score, the reward redemption flag, and the authentication challenge.

13. A verification computer device in accordance with claim 10, wherein the reward redemption flag is set when the payment transaction includes a reward redemption initiated by the cardholder.

14. A verification computer device in accordance with claim 13, wherein the reward redemption is initiated by the cardholder providing a unique reward code to the originating merchant.

15. A verification computer device in accordance with claim 14, wherein the unique reward code provides a discount on the payment transaction.

16. A verification computer device in accordance with claim 14, wherein the unique reward code is provided to the cardholder from a merchant loyalty scheme associated with the originating merchant.

17. A verification computer device in accordance with claim 14, wherein the unique reward code is uniquely correlated with the cardholder and the unique reward code is for a single use.

18. A verification computer device in accordance with claim 14, wherein the unique reward code is provided to the cardholder based on one or more purchases associate with the originating merchant

19. At least one non-transitory computer-readable storage media having computer-executable instructions embodied thereon, wherein when executed by a verification computer device having at least one processor coupled to at least one memory device, the computer-executable instructions cause the processor to:
receive an authentication request message for a payment transaction originating from an originating merchant for a cardholder, the authentication request message includes a reward redemption flag;
determine that an authentication challenge is needed based on the authentication request message;
if the reward redemption flag is not set, transmit an authentication challenge to the user;
if the reward redemption flag is set, determine that the authentication challenge may be bypassed based on the reward redemption flag;
generate an authentication response message based, at least in part, on at least one of reward redemption flag and the authentication challenge; and
transmit the authentication response message to the originating merchant.

20. The computer-readable storage medium of claim 19, wherein the computer-executable instructions further cause the processor to:
determine a fraud score for the cardholder based on the authentication request message;
determine that an authentication challenge is needed based on the fraud score; and
generate the authentication response message based, at least in part, on the fraud score, the reward redemption flag, and the authentication challenge.
